(19) United States
(12) Patent Application Publication
(10) Pub. No.: US 2024/0328387 A1
(43) Pub. Date: Oct. 3, 2024

(54) METHODS AND SYSTEMS OF CLOSED LOOP COLLABORATIVE WIND PLANT CONTROL

(71) Applicant: WindESCo, Inc., Boston, MA (US)

(72) Inventors: Peter Bachant, Cambridge, MA (US); Peter Ireland, Boston, MA (US); Brian Burrows, Boston, MA (US); Venkatakrishna Vadlamudi, Bengaluru (IN); Nathan L. Post, Portland, ME (US); Mohit Dua, Boston, MA (US); Danian Zheng, Boston, MA (US)

(21) Appl. No.: 18/619,629

(22) Filed: Mar. 28, 2024

Related U.S. Application Data
(60) Provisional application No. 63/455,316, filed on Mar. 29, 2023.

(51) Int. Cl. F03D 7/04

(52) U.S. Cl. CPC F03D 7/049; F03D 7/045; F03D 7/046; F05B 2260/84; F05B 2270/32; F05B 2270/321

(57) ABSTRACT

Systems and methods of predicting performance of one or more wind turbines are provided. Exemplary methods include entering data inputs and analyzing and estimating the data inputs. The data inputs include nacelle position information and/or wind condition information. A wake model is determined based on the analysis and estimating of the data inputs. Wind turbine behavior predictions are generated including predicted power outputs of the wind turbines and predicted effects of waking on the predicted power outputs. The data inputs can be adjusted to improve the wind turbine behavior predictions, and the wake model can be corrected by machine learning. By focusing on an observable quantity—power—based on other observable quantities like wind speed, yaw error, nacelle position, disclosed embodiments enable optimization to start immediately after the hardware and software are installed, and as the controller operates more in the field, additional training and validation data are collected.

### CROSS-REFERENCE TO RELATED APPLICATION

This application is a non-provisional of and claims priority to U.S. Patent Application No. 63/455,316, filed Mar. 29, 2023, which is hereby incorporated by reference in its entirety.

### FIELD

The present disclosure relates to wind plant power prediction and control.

### BACKGROUND

Wind plant control is an emerging field that promises improved plant energy production and reliability. In wind plant control, at least some aspects of turbine operation are determined at the plant level rather than at the individual turbine level, Wind plant control can be used to gain a better picture of the true wind field, which in turn can inform control decisions. One example is the mitigation of wake losses through wake steering, where upstream turbines misalign themselves to deflect the slower and more turbulent flows in their wakes away from downstream neighbors.

Collective plant control is typically based on static lookup tables (LUT). These tables are usually limited to several independent variables to describe wind conditions, meaning such systems will almost certainly fall short of the full potential for collective control. More advanced “closed—loop” processes that continuously update models for computing optimum control outputs have only been tested in simulation in the literature. Even these studies have been limited in scope as to the model parameters being estimated and their applicability to the kinds of input data that would be more realistically available at a typical wind plant. For example, they may rely on perfectly simulated flow data (missing the noise and biases present in real sensor data) or on expensive LiDAR measurement campaigns to “train” a model.

One approach is to use a model-based wind plant control system that depends on only turbine SCADA data for inputs. This wind plant model may be based on an engineering wake model called FLORIS that computes turbine power and wake locations quickly enough to be used directly in a control application. This model can account for which turbines are currently generating power and can be controlled. However, this controller has deficiencies due to its open loop nature and thus reliance on fixed assumptions about the wake interactions of the turbines.

Due to constraints on available land, wind plants are often laid out such that in certain wind conditions, some turbines will end up operating in the wake—the region of slowed flow behind the rotor—of other turbines. When a turbine is waked, its incoming wind speed, and therefore the available energy in the flow, is reduced, and if this wind speed is below the rated wind speed of the turbine, it will underperform its unwaked peers, reducing the overall output of the plant. It is estimated that wake losses of typical wind plants range from 5 to 20 percent.

There has therefore been a continued effort to find ways to control turbine wakes to mitigate these losses, One such technique is called wake steering, where the upstream (steering) turbine is intentionally misaligned relative to the free stream wind direction to deflect the wake away from the downstream (waked) turbine. This so-called yaw misalignment reduces the power of the steering turbine, but the increase in power from the downstream turbine may be greater than these losses, providing a net gain for the plant.

Research has been focused on developing computationally efficient engineering models of the wake steering phenomenon. These models have been validated with high fidelity simulations such as large eddy simulation (LES, a mostly first-principles-based computational fluid dynamics technique), scaled model wind tunnel tests, and relatively simple field tests to observe how the flow is deflected in a simple wake steering scenario. Often, field experiments use sensor systems that are not financially viable for model calibration and validation on large commercial wind plants. LES simulations are too computationally costly to fully study the accuracy of engineering models over large wind plants and the diverse conditions in which they are used, which includes variable atmospheric stability, terrain effects, diurnal cycles, sensor misalignment, and sensor drift.

In conventional control problems, e.g., feedback control of a motor, an objective function can be defined as the minimization of the error between a desired setpoint speed and its measured value. In wake steering control, however, the objective is to maximize plant power—the sum of all individual turbines' powers—which is a function of the wind conditions and turbine nacelle positions. Neither (his function nor its gradient is known analytically, so there is no way to compute the distance, or error, of the plant power from its hypothetical optimum value achievable under wake steering. Without the ability to compute the error, conventional feedback control techniques cannot be employed.

This complexity makes wake steering a perfect candidate for so-called model-based control (MBC), where a model of the objective function is used to predict the consequences of various setpoint values, which can be used in conjunction with an optimization algorithm to find optimal values.

Several wind plant wake models designed for use in control systems exist, One such model is NREL's FLORIS. A wake steering system using FLORIS in the loop to compute optimum nacelle position setpoints has been implemented. This is a large step up from LUT or static offset implementations, but still suffers from inaccuracies due to the fact that the model is “open loop.” A so-called “closedloop” model would adapt to reduce the error in its predictions, improving its predictive accuracy and therefore its ability to compute optimal setpoints over time.

To date, research into closed loop model based wake steering control has been relegated to high fidelity simulations and wind tunnel tests. The focus has been on developing the processes used to close the loop. However, the adaptation of these engineering wake models to use with real world data has not yet been addressed. This is critical since real-world data will contain noise and biases not present in simulation data. For example, FLORIS requires the inputs to represent the free stream wind conditions (i.e., without any turbines present). In academic studies, this is estimated in several ways. Field campaigns have used LiDAR to measure the flow in front of the turbines. Wind tunnel tests use particle image velocimetry similarly. LES simulations have access to the simulated free stream flow directly.

However, the wind sensors on typical wind turbines will be located on the nacelle behind the rotor, operating in a flow that is not representative of the ambient or free stream flow. The current state of the art does not adequately address the questions of how one relates these measurements to inputs the wake model expects, and how errors in that input translation step can be minimized by continuously adapting to reduce the model prediction error, such that the model predicts real-world operation accurately enough for optimization.

Thus, there is a need for more advanced systems and methods of wind plant power prediction and control. There is a need for systems and methods of power prediction and wake model prediction, calibration, and validation using readily available data. There also is a need for systems and methods that allow real-world SCADA data to be used as inputs to generate accurate plant behavior predictions such as the power outputs of the turbines and the effect of waking on these outputs.

### SUMMARY

Embodiments of the present disclosure provide improved wind plant prediction and control capabilities through a model calibration and validation pipeline that uses data that will always be available during typical operation and can therefore be continuously retrained as more data comes in, thus closing the loop. These calibrations can be thought of as an input translation layer that converts real-world SCADA data into inputs suitable for FLORIS to allow accurate plant behavior predictions, i.e., the power outputs of all the turbines and the effect of waking on these outputs. Model inputs that are estimated include, but are not limited to, wind direction, wind speed, turbulence intensity, turbine power curves, and power losses due to yaw. A combination of analytical calibrations and machine learning models are used to generate a pipeline for maintaining accurate predictions over the lifetime of the plant.

An exemplary method of predicting performance of one or more wind turbines comprises entering data inputs, analyzing and estimating the data inputs, determining a wake model based on the analysis and estimating of the data inputs, and providing wind turbine behavior predictions. The predictions include predicted power outputs of the one or more wind turbines and predicted effects of waking on the predicted power outputs. In exemplary embodiments, the data inputs comprise nacelle position information and wind condition information and may further comprise ambient temperature and observed power of the one or more wind turbines. The wind condition information includes ambient wind speed, ambient wind direction, and/or ambient turbulence intensity. Exemplary methods further comprise entering additional data inputs and adjusting the data inputs to improve the wind turbine behavior predictions. The turbine nacelle positions may be altered to maximize power of a plurality of wind turbines. The wake model may be corrected by machine learning.

Exemplary embodiments of a system to predict performance of one or more wind turbines comprise a data computation unit analyzing data inputs and estimators transforming the data inputs into model inputs, and a wake modeler in communication with the data computation unit. Each wind turbine includes a nacelle, a turbine control unit, a yaw drive, and one or more wind direction sensors attached to the wind turbine. The wake modeler provides outputs including a wake model based on the analysis of the data inputs and model inputs. The wake modeler also provides wind turbine behavior predictions including predicted power outputs of the one or more wind turbines and predicted effects of waking on the predicted power outputs.

The data computation unit may be an edge IoT device, a turbine control unit, or any other suitable computer or device or may sit in the cloud. In exemplary embodiments, the system further comprises a machine learning model in communication with the wake modeler that corrects the outputs of the wake modeler. The system may alter turbine nacelle positions to maximize power of a plurality of wind turbines. The data inputs may include nacelle position information and wind condition information, and the wind condition information may include ambient wind speed, ambient wind direction, and/or ambient turbulence intensity.

An exemplary method of predicting performance of one or more wind turbines comprises entering data inputs, analyzing and estimating the data inputs, determining a wake model based on the analysis and estimating of the data inputs, providing wind turbine behavior predictions, and adjusting the data inputs to improve the wind turbine behavior predictions. The data inputs may include, but are not limited to, nacelle position information and/or wind condition information. The wind turbine behavior predictions may include, but are not limited to, predicted power outputs of the one or more wind turbines and predicted effects of waking on the predicted power outputs.

Exemplary methods further comprise determining error in the wind turbine behavior predictions where the determining error step includes determining a difference between observed power and predicted power. The wake model may be corrected by machine learning. In exemplary embodiments, the data inputs comprise SCADA data. Exemplary methods further comprise altering turbine nacelle positions to maximize power of a plurality of wind turbines.

Accordingly, it is seen that systems and methods of predicting performance of wind turbines are provided. These and other features and advantages will be appreciated from review of the following detailed description, along with the accompanying figures in which like reference numbers refer to like parts throughout.

### BRIEF DESCRIPTION OF THE DRAWINGS

The foregoing and other objects of the disclosure will be apparent upon consideration of the following detailed description, taken in conjunction with the accompanying drawings, in which:

FIG. 1 is a perspective view of an exemplary embodiment of a wind plant in accordance with the present disclosure;

FIG. 2 is a side view of an exemplary embodiment of a wind turbine nacelle in accordance with the present disclosure;

FIG. 3 is a side view of an exemplary embodiment of a wind turbine nacelle showing an exemplary retrofit system for a wind turbine including a retrofit data communication and processing unit installed between the existing wind direction sensor and the turbine control unit in accordance with the present disclosure;

FIG. 4 is a process flow diagram showing an exemplary embodiment of a system and method of predicting performance of one or more wind turbines in accordance with the present disclosure;

FIG. 5 is a process flow diagram showing an exemplary embodiment of a system and method of predicting performance of one or more wind turbines in accordance with the present disclosure;

FIG. 6 is a process flow diagram showing exemplary estimators for a system and method of predicting performance of one or more wind turbines in accordance with the present disclosure;

FIG. 7 is a perspective view of an exemplary system for predicting performance of one or more wind turbines and controlling group or wind farm level yaw control behavior in accordance with the present disclosure;

FIG. 8 is a schematic of an exemplary system for predicting performance of one or more wind turbines and controlling group or wind farm level yaw control behavior in accordance with the present disclosure; and

FIG. 9 is a block diagram showing an exemplary embodiment of the internal structure of a computer in which various embodiments of the disclosure may be implemented.

### DETAILED DESCRIPTION

In the following paragraphs, embodiments will be described in detail by way of example with reference to the accompanying drawings, which are not drawn to scale, and the illustrated components are not necessarily drawn proportionately to one another. Throughout this description, the embodiments and examples shown should be considered as exemplars, rather than as limitations of the present disclosure. As used herein, the “present disclosure” refers to any one of the embodiments described herein, and any equivalents. Furthermore, reference to various aspects of the disclosure throughout this document does not mean that all claimed embodiments or methods must include the referenced aspects.

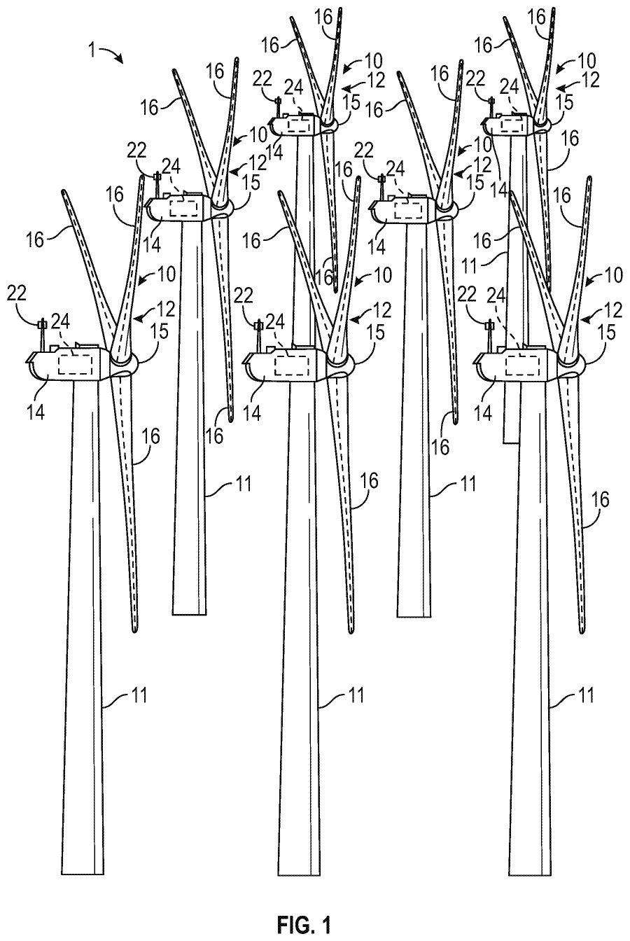

Embodiments of the present disclosure provide methods and systems of predicting performance, particularly, power outputs of wind turbines. An exemplary wind farm 1 is shown in FIG. 1. A wind farm or wind plant 1 includes a plurality of wind turbines 10. Each wind turbine 10 has a tower 11, a rotor 12, and a nacelle 14 mounted to the top of the tower 11 along with a yaw bearing 9. The rotor 12 has a plurality of rotor blades 16 coupled to and extending from a rotor hub 15. The rotor hub 15 is rotatably coupled to an electric generator 17 via the main shaft 3.

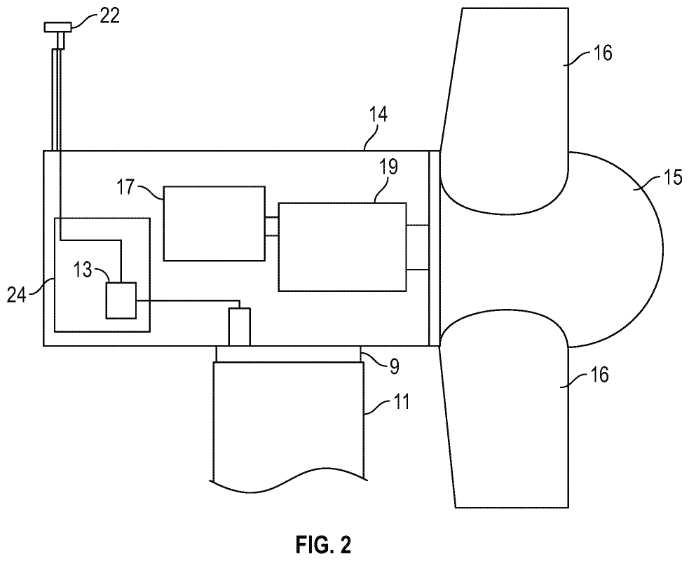

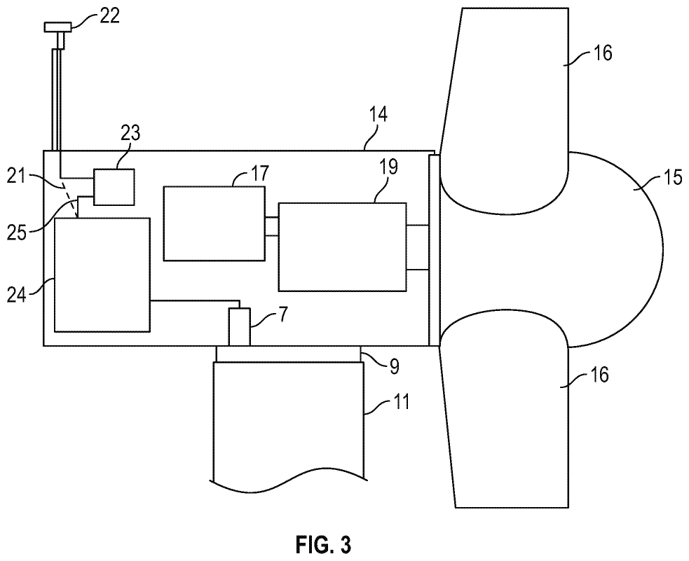

FIGS. 2 and 3 illustrate the major components in the nacelle 14. Various mechanical, electrical and computer systems, including but not limited to, the electric generator 17, a gearbox 19, a yaw motor/drive 7, and a turbine control unit 24, may be housed in the nacelle 14. An auxiliary yaw position control system 23 may be added to the wind turbine 10 or located remotely from the turbine, as described in U.S. Pat. No. 11,313,351, issued Apr. 26, 2022, and U.S. Pat. No. 11,680,556, issued Jun. 20, 2023, each of which is hereby incorporated by reference herein in its entirety. This auxiliary system 23 is an addition to the existing yaw controller software and hardware on the turbine that comprises the turbine control system. Optionally, a vane or sonic anemometer or other sensor 22 is provided, including a wind direction sensor and a GNSS compass including GNSS antennas and a GNSS differential receiver.

The approach of disclosed embodiments is to focus on ensuring the prediction method 2, or model calibration and validation pipeline, can accurately make predictions of performance under current conditions to effectively optimize the wind plant 1. In exemplary embodiments, the prediction is the power of each wind turbine 10 as a function of its nacelle 14 position and the wind conditions, as can be observed or estimated from typically available SCADA data. Information such as which turbines 10 are currently operating is also important. Disclosed embodiments focus on being able to predict the effects of waking and unwaking on turbine power, and in particular, how waking is affected by turbine nacelle 14 positions and wind conditions, since the turbine control unit 24 will attempt to alter turbine nacelle positions to maximize power of a plurality of wind turbines or the entire wind plant.

This is particularly advantageous when considered in contrast to other approaches that focus on validating the ability of the model to make predictions related to first principles, e.g., the position of the center of the wake, or the deflection angle caused by upstream yaw. These approaches make sense academically, since these models typically predict aspects of the flow physics, but will likely take longer to make an impact commercially, since they require potentially expensive and time-consuming measurement campaigns.

The present disclosure is focused on predicting an observable quantity-power—based on other observable quantities like wind speed and yaw error (both measured at the nacelle 14 by a sonic anemometer or other wind measurement device 22) and nacelle position (measured by both the yaw system and potentially by a global navigation satellite system—GNSS—compass), Advantageously, this approach enables optimization to start immediately after the requisite hardware and software is installed, and as the turbine control unit 23 operates more in the field, additional training and validation data can be collected. This continuous process of validation and recalibration is therefore how the loop is closed over an extended period of time and with experience of how the wind plant behaves.

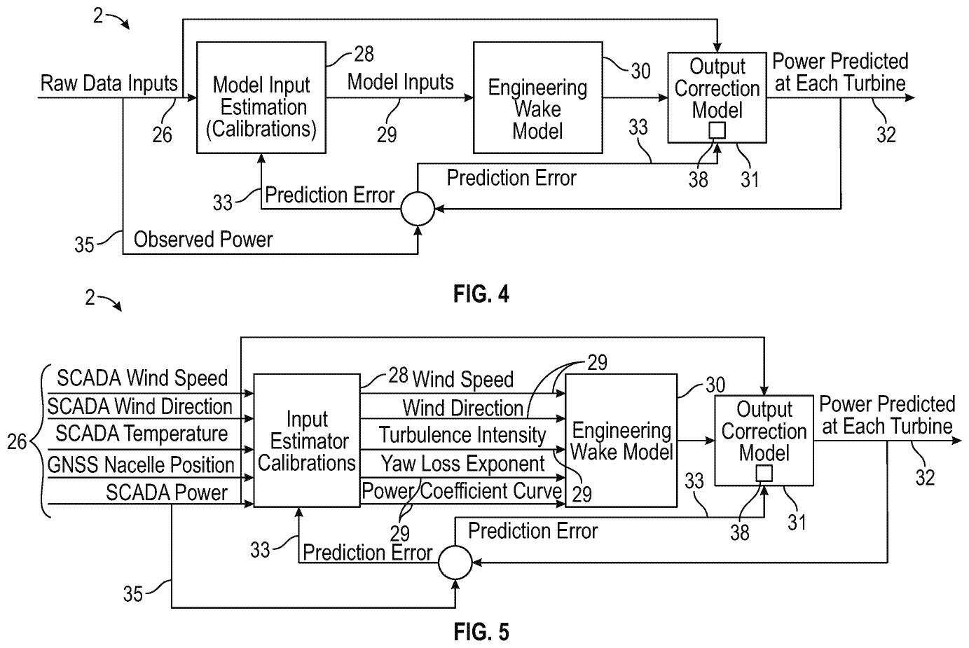

With reference to FIGS. 4 and 5, exemplary turbine performance prediction methods 2 will now be described, A schematic of the basic model architecture and data flow is shown in FIG. 4. The raw data inputs 26 are entered into the system, specifically into a data computation unit 28. In exemplary embodiments, the data computation unit is the turbine control unit 24, or it could be an edge IoT device or any other suitable computer, device, or software, or may sit in the cloud. The methods 2 may be implemented at a wind plant I on a central server, on individual computers installed on each turbine, or on a remote or cloud hosted server communicatively coupled to the wind plant I through the internet or a private network. They may initially be operated untrained with default settings and by collecting data overtime either automatically or manually re-calibrated to the data collected so far. Continuous learning techniques may be incorporated to update the estimator calculations on the fly as more information becomes available.

The data inputs 26 include, but are not limited to, wind direction, wind speed, temperature, nacelle position, power, turbulence intensity, turbine power curves, and power losses due to yaw, and other signals typically recorded in the SCADA system (e.g., rotor speed and pitch angle and turbine curtailment). FIG. 5 shows some of the important data inputs 26, which could vary depending on conditions at the wind plant site, A person of skill in the art would be able to select the necessary inputs. The initial set of calibrations includes estimators 36 for determining, e.g., the ambient wind direction, ambient wind speed, ambient turbulence intensity, power yaw exponent, which describes the loss of power due to yaw misalignment, and turbine power coefficient as a function of ambient wind speed.

In exemplary embodiments, these estimators 36 may rely only on available high frequency SCADA data and estimates of the wind and nacelle directions at each turbine. The raw measured values may be computed locally by the Edge IoT device using a sonic anemometer 22 and GNSS compass or derived from SCADA data from the turbine control units 23 themselves or a combination.

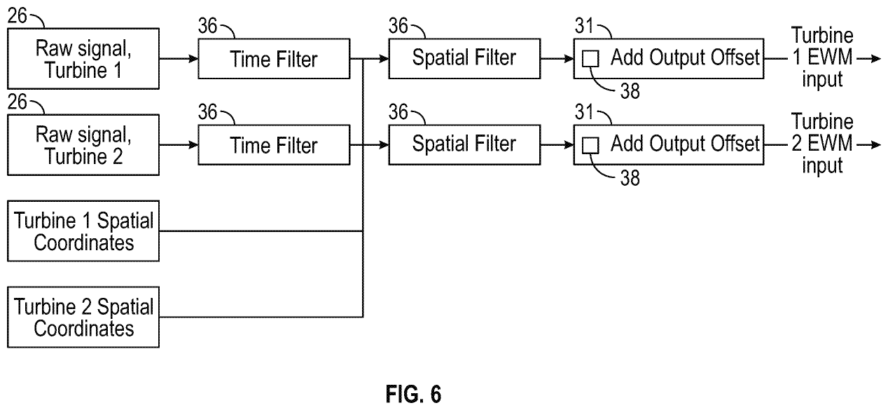

As shown in FIG. 6, wind estimators 36 transform raw input data coming from the SCADA system and additional sensors into model inputs 29 acceptable to the engineering wake model. Different types of estimators can be used for different inputs, e.g., there can be different signal conditioning for estimating wind speed versus wind direction. A basic example of an estimator 36 is a linear function of the measured values with unknown parameters for the slope and offset, A more complex example is to use a machine learning neural network 38 that weights the different signal combinations at a series of nodes to relate the inputs to the outputs. In any case, the appropriate parameters are determined by minimizing the measured error in the power during periods of interest.

The data computation unit 28 sends model inputs 29 to a wake modeler 30. These model inputs could include, but are not limited to, wind speed, wind direction, turbulence intensity, a yaw loss exponent, and a power coefficient curve, Based on the analysis of the data inputs by the input estimators or calibrations, a wake model may be determined by the wake modeler 30. The wake model, in turn, helps the system to predict wind turbine behavior such as the predicted power outputs of the wind turbines 10. This is because the predicted effects of waking on the predicted power outputs 32 can be assessed.

The disclosed approach can be deployed without being trained because the engineering wake model produces adequate initial results without the input calibrations or an output corrector. It also advantageously has the ability to predict the consequences of yaw misalignments not seen in the training data, since power loss due to yaw is an analytical model. This means the model can start optimization earlier without a lengthy, and potentially costly, training data collection campaign.

In addition, various tools can be employed to improve the turbine behavior predictions such as entering additional data inputs 26 and/or adjusting the data inputs. To further improve the results, additional estimators 36 for other model parameters may be added, e.g., an estimate of the wind shear. This might require additional sensors on a met tower or LIDAR that can measure the wind shear. Alternatively, the wind shear input may be estimated from other observable values such as the turbulence intensity, bending moments on the turbine, etc. In exemplary embodiments where the physics based model used is NREL FLORIS, the method may adjust the input estimators (calibrations) to improve the predictive capability of FLORIS.

It is important to determine how prediction error 33 should be calculated to then enable the calculations (analytical equations and/or ML models) to be adjusted to minimize the error by an output correction model 31. In exemplary embodiments, the difference between observed power 35 and predicted power 32 is selected. The system also may make further refinements to focus on the situations in which the wake model needs to perform well, e.g., situations where waking/unwaking is happening. This focused error function advantageously enables optimization of the process to produce the best performance where it counts. Further, the error function may focus on accuracy of predictions at the timescale of interest (e.g. one minute), typically the response period of the wind farm optimization controller and a reasonable response time for the turbine yaw drives to reach target values.

It is also possible that further corrections may be required, for example, due to more complex terrain on the wind plant changing the flows and wake patterns beyond what the physics-based model can capture. Exemplary embodiments include an additional machine learning (ML) model 38 to “correct” the output of the wake model along with estimating the correct inputs. Other wake models may be used in lieu of FLORIS—as long as they compute turbine power values efficiently enough to enable optimization of the wind plant in real time.

Disclosed embodiments could be used in conjunction with systems and methods of controlling group or wind farm level yaw control behavior at a wind plant, as described in U.S. Pat. No. 11,639,710, issued May 2, 2023, and co-pending U.S. patent application Ser. No. 18/141,597, filed May 1, 2023, each of which is hereby incorporated by reference in its entirety. As described in U.S. Pat. No. 11,639,710 and application Ser. No. 18/141,597, exemplary methods and systems for controlling group or wind farm level yaw control behavior at a wind plant improve plant performance by making improvements at four levels. At the turbine level, disclosed systems provide more accurate relative wind direction measurement and improve responsiveness of turbine yaw control with additional dynamic yaw control tuning optimization based on the high-speed turbine wind direction sensor history. At site level, systems and methods eliminate yaw zero error or yaw misalignment regularly online in a higher frequency at seconds to minutes based on environmental conditions such as air density, temperature and turbulence.

Once improved, individual turbine yaw control accuracy and performance consider neighboring turbines' measured wind directions to come up with the wind direction flow across a group of turbines 10 or a whole farm 1. Fourth, based on the overall farm level wind speed and the accurate yaw positions across the group of wind turbines 10 or the wind farm 1, the systems deploy a wake steering model such as the NREL FLORIS model. This controls the upstream turbines at the moment to yaw away from wind enough for the downstream turbines to achieve higher production, thereby improving the overall group or farm level power production as a whole. This four-level methodology improves the farm level production by as much as 3-5% of the annual energy production. The final control output at system level is the desired turbine nacelle direction. It should be noted that there could be multiple opportunities to guide the turbine to point to the directions the group or wind farm level controller desires.

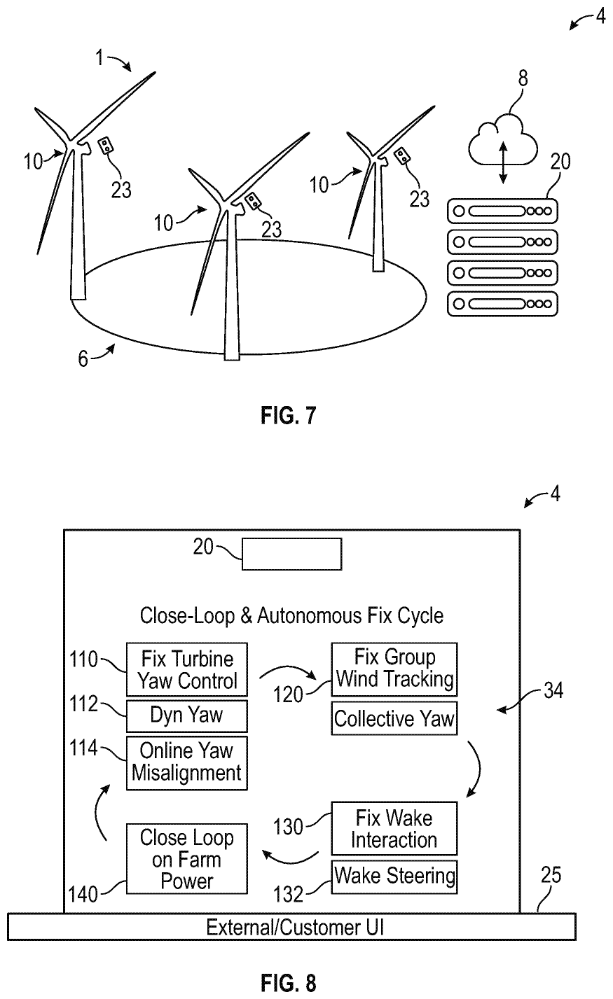

Turning to FIGS. 7 and 8, an exemplary embodiment of a system 4 of improving wind turbine performance based on disclosed prediction methods will now be described. The system 4 has a coordinated yaw controller 20 that provides control of multiple wind turbines 10. In exemplary embodiments, the coordinated yaw controller 20 is a site level edge device such as an edge computer or sits in the cloud 8 and collects and analyzes yaw control data from the wind turbines 10. More particularly, coordinated yaw controller 20 is a wind turbine group or wind farm level control system implemented in the edge computer or in the cloud 8 that collects high speed wind direction and yaw control inputs and outputs data. It also sends out the yaw control signals to each turbine control unit 24 via an extra control module or unit.

Exemplary implementations could have portions of control systems or processes on edge or cloud computing. Wind plant network communication could be wired or wireless. A GUI and/or wizard-like user interface 25 may be provided for monitoring and controlling the system 2 remotely. The GUI at the wind plant may include real-time feedback on system behavior and on/off control. A cloud GUI may be read-only and may be slightly behind real time, displaying the cumulative benefit.

In exemplary embodiments, the coordinated yaw controller 20 determines the collective wind direction across the area 6 of the wind farm 1, also at wind turbine group or wind farm level. The coordinated yaw controller 20 collects the turbine yaw control inputs and outputs high frequency data while monitoring how each wind turbine yaw control behaves. It may send out a yaw bias signal to help the turbine yaw control to achieve better accuracy and response time. The coordinated yaw controller analyzes the high frequency power data to determine how much the yaw misalignment is present for each turbine at current time and send a correction offset signal to each wind turbine 10.

The individual wind turbines 10 could be controlled by any suitable extra controller. One approach is to use the original turbine control software and add a new module inside, e.g., an additional SW module inside the turbine control unit. In exemplary embodiments, the SW module receives the yaw bias command from the coordinated yaw controller in the edge computer or cloud and drives the wind turbine 10 to the position at the speed the coordinated yaw controller 20 desires.

Alternatively, each individual wind turbine could be equipped with a retrofit data communication and processing unit 23 as part of a retrofit system 4 as described in U.S. Pat. Nos. 11,313,351; 11,680,556. The retrofit data communication and processing unit 23 receives nacelle yaw position commands and other signals from the coordinated yaw controller 20 and the technology feeds fictitious yaw error and wind speed signals to the turbine control unit 24 and measures the response. This hardware may be installed on the turbine 10 to enable farm level yaw control for the turbine and to provide accurate timely data regarding the nacelle yaw position and measured wind conditions at the turbine to the system.

With reference to FIG. 8, an exemplary system 4 operates in a closed loop, and the coordinated yaw controller 20 drives an autonomous fix cycle 34. The fix cycle 34 includes improving or fixing 110 turbine yaw control, fixing 120 group wind tracking, fixing 130 wake interaction, and closing 140 the loop on wind farm power. As discussed in more detail herein, the turbine yaw control fix 110 could be by dynamic yaw control 112 and/or yaw misalignment correction 114. At a group level, the group wind tracking fix 120 is by collective yaw control 122. The wake interaction fix 130 may be by a wake steering model 132.

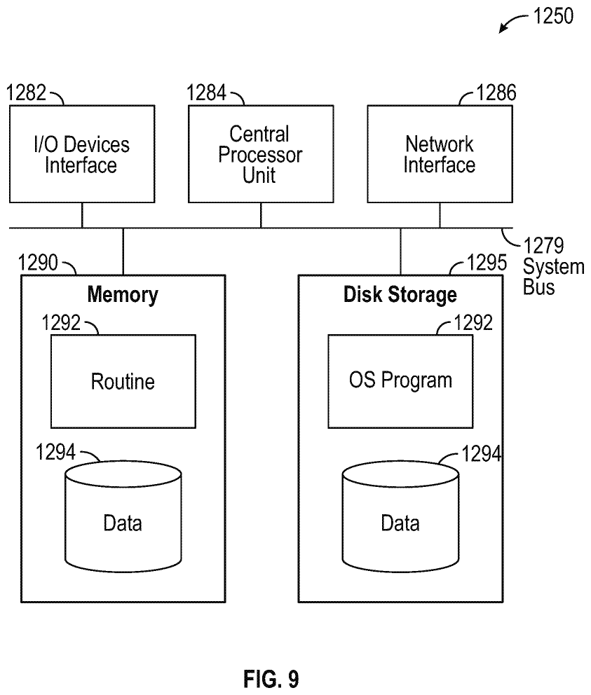

FIG. 9 shows an exemplary internal structure of a computer 1250 in which various embodiments of the present disclosure may be implemented. For example, the computer 1250 may act as a coordinated yaw controller 20. The computer 1250 contains a system bus 1279, where a bus is a set of hardware lines used for data transfer among the components of a computer or processing system. Bus 1279 is essentially a shared conduit that connects different elements of a computer system (e.g., processor, disk storage, memory, input/output ports, network ports, etc.) that enables the transfer of information between the elements. Attached to system bus 1279 is I/O device interface 1282 for connecting various input and output devices (e.g., sensors, transducers, keyboard, mouse, displays, printers, speakers, etc.) to the computer 1250. Network interface 1286 allows the computer 1250 to connect to various other devices attached to a network (e.g., wind farm system, SCADA system, wind farm controller, individual turbine control units, weather condition sensors, data acquisition system etc.).

Memory 1090 provides volatile storage for computer software instructions 1292 (e.g., instructions for the processes/calculations described above, for example, receiving operating state information from the wind farm system and sensor data from the sensors and data 1294 used to implement embodiments of the present disclosure. Disk storage 1295 provides non-volatile storage for computer software instructions 1292 and data 1294 used to implement an embodiment of the present disclosure. Central processor unit 1284 is also attached to system bus 1279 and provides for the execution of computer instructions.

In an exemplary embodiment, the processor routines 1292 (e.g., instructions for the processes/calculations described above) and data 1094 are a computer program product (generally referenced 1292), including a computer readable medium (e.g., a removable storage medium such as one or more DVD-ROMs, CD-ROMs, diskettes, tapes, etc.) that provides at least a portion of the software instructions for the invention system. Computer program product 1292 can be installed by any suitable software installation procedure, as is well known in the art.

In another embodiment, at least a portion of the software instructions may also be downloaded over a cable, communication and/or wireless connection. Further, the present embodiments may be implemented in a variety of computer architectures. The computer of FIG. 9 is for purposes of illustration and not limitation of the present disclosure. In some embodiments of the present disclosure, the data analysis and augmented control system may function as a computer to perform aspects of the present disclosure.

Thus, it is seen that systems and methods of predicting performance of one or more wind turbines are provided. It should be understood that the example embodiments described above may be implemented in many different ways. In some instances, the various methods and machines described herein may each be implemented by a physical, virtual or hybrid general purpose computer having a central processor, memory, disk or other mass storage, communication interface(s), input/output (I/O) device(s), and other peripherals. The general purpose computer is transformed into the machines that execute the methods described above, for example, by loading software instructions into a data processor, and then causing execution of the instructions to carry out the functions described, herein. Embodiments may therefore typically be implemented in hardware, firmware, software, or any combination thereof.

While embodiments of the disclosure have been particularly shown and described with references to example embodiments thereof, it will be understood by those skilled in the art that various changes in form and details may be made therein without departing from the scope of the invention encompassed by the appended claims. For example, the disclosed augmented control is described in the context of wind farms and wind turbines, but may be applied to augment control of other turbines, such underwater turbines.

What is claimed is:

1. A method of predicting performance of one or more wind turbines, comprising:
entering data inputs;
analyzing and estimating the data inputs;
determining a wake model based on the analysis and estimating of the data inputs; and
providing wind turbine behavior predictions including predicted power outputs of the one or more wind turbines and predicted effects of waking on the predicted power outputs.

2. The method of claim 1 wherein the data inputs comprise nacelle position information and wind condition information.

3. The method of claim 2 wherein the wind condition information includes one or more of: ambient wind speed, ambient wind direction, or ambient turbulence intensity.

4. The method of claim 2 wherein the data inputs further comprise ambient temperature and observed power of the one or more wind turbines.

5. The method of claim 1 further comprising adjusting the data inputs to improve the wind turbine behavior predictions.

6. The method of claim 1 further comprising correcting the wake model by machine learning.

7. The method of claim 1 further comprising altering turbine nacelle positions to maximize power of a plurality of wind turbines.

8. A system to predict performance of one or more wind turbines, each wind turbine including a nacelle, a turbine control unit, a yaw drive, and one or more wind direction sensors attached to the wind turbine, comprising:
a data computation unit analyzing data inputs and including estimators transforming the data inputs into model inputs;
a wake modeler in communication with the data computation unit, the wake modeler providing outputs including a wake model based on the analysis of the data inputs and the model inputs and wind turbine behavior predictions including predicted power outputs of the one or more wind turbines and predicted effects of waking on the predicted power outputs.

9. The system of claim 8 wherein the data computation unit is an edge IoT device or a turbine control unit.

10. The system of claim 8 wherein the system alters turbine nacelle positions to maximize power of a plurality of wind turbines.

11. The system of claim 8 further comprising a machine learning model in communication with the wake modeler.

12. The system of claim 11 wherein the machine learning model corrects the outputs of the wake modeler.

13. The system of claim 8 wherein the data inputs comprise nacelle position information and wind condition information.

14. The system of claim 13 wherein the wind condition information includes one or more of: ambient wind speed, ambient wind direction, or ambient turbulence intensity.

15. A method of predicting performance of one or more wind turbines, comprising:
entering data inputs including one or more of: nacelle position information and wind condition information;
analyzing and estimating the data inputs;
determining a wake model based on the analysis and estimating of the data inputs;
providing wind turbine behavior predictions including predicted power outputs of the one or more wind turbines and predicted effects of waking on the predicted power outputs; and
adjusting the data inputs to improve the wind turbine behavior predictions.

16. The method of claim 15 further comprising determining error in the wind turbine behavior predictions.

17. The method of claim 16 wherein the determining error step includes determining a difference between observed power and predicted power.

18. The method of claim 15 further comprising correcting the wake model by machine learning.

19. The method of claim 15 wherein the data inputs comprise SCADA data.

20. The method of claim 15 further comprising altering turbine nacelle positions to maximize power of a plurality of wind turbines.
